(19) United States
(12) Patent Application Publication
(10) Pub. No.: US 2010/0156630 A1
(43) Pub. Date: Jun. 24, 2010

(54) Contextual Risk Indicators in Connection with Threat Level Management

(76) Inventor: Robert Ainsbury, Woodbury, MN (US)

Correspondence Address: GLENN PATENT GROUP, 3475 EDISON WAY, SUITE L, MENLO PARK, CA, 94025, US

(21) Appl. No.: 12/402,274

(22) Filed: Mar. 11, 2009

Related U.S. Application Data
(62) Division of application No. 12/338,668, filed on Dec. 18, 2008.

(51) Int. Cl. G08B 21/00

(52) U.S. Cl. 340/540

(57) ABSTRACT

A system is provided that that allows users to define factors that uniquely affect the security risk of certain events at a certain locale. The system can then change its behavior based on these custom risks and invoke various counter measures when threats are more likely. Accordingly, one embodiment of the invention provides for the use of contextual risk indicators in connection with threat level management.

### CROSS REFERENCE TO RELATED APPLICATIONS

This application is a divisional application of U.S. patent application Ser. No. 12/338,668 (attorney docket no. TTAN0001), filed 18 Dec. 2008, which application is incorporated herein in its entirety by this reference thereto.

### BACKGROUND OF THE INVENTION

1. Technical Field

The invention relates to protecting sensitive facilities from elevated threats. More particularly, the invention relates to the use of contextual risk indicators in connection with threat level management.

2. Description of the Prior Art

Serious and potentially catastrophic threats are a reality across the globe in today's political climate, and it seems that no geography or culture is immune from terrorism. Once the domain of war and armed conflict, serious and deadly attacks are occurring in cities in the East, West, North and South.

One of the most used and deadly weapons employed by terrorists today is the car bomb or, to use the industry vernacular, vehicle borne improvised explosive device, VBIED for short.

Here are some quotes from experts on the use of, and threat from, VBIEDs:

“Terrorists have repeatedly used heavy vehicles to conduct VBIED attacks in other countries as well as the United States . . . terrorist planners consider trucks to be one of the best tools to breach security measures and carry explosives.”(US Department of Homeland Security)

“The use of VBIEDs allow terrorists to place large amounts of explosives against hard or soft targets with a high degree of mobility—in effect turning these VBIEDs into precision weapons that cause mass casualties and physical destruction. VBIED attacks require less coordination, planning, expertise, material, and money than the more spectacular type of terrorist methods, such as aircraft hijackings or employment of weapons of mass destruction, yet still can achieve the mass casualty objective . . . ” (US Coast Guard)

“Terrorists continue to select soft targets for attack—particularly those that will yield a high casualty count. Some examples, though not all inclusive, are: residences, recreational and shopping venues, and business buildings and complexes. All available antiterrorism measures should be rigorously reexamined . . . ” (US Department of Homeland Security)

In view of the continuing risk to property and human life attendant with such malicious acts of terrorism as car bombing and the like, it would be advantageous to provide techniques for establishing threat levels and managing risks within each such threat level.

Given the applicability of different tactics and strategies to different facilities, and even at different locations within a facility, it would be further advantageous to provide for the use of contextual risk indicators in connection with threat level management.

### SUMMARY OF THE INVENTION

Security professionals have the significant challenge of trying to secure a location against significant and real threats without turning the facility into a fortress. If too many countermeasures are deployed, operations are brought to a standstill. More often than not, unless faced with imminent danger, operational leadership compromises security to allow operations to proceed. It is this reality that spurred the making of the invention, which provides security systems that modify their behavior automatically as threat levels fluctuate.

Threat levels are not a new concept in the security field, and even lay people are familiar with the threat levels adopted by the US Department of Homeland Security. An embodiment of the invention, as with much of the industry, uses four threat levels. The Dept. of Homeland Security uses a five level system. In an embodiment of the invention, threat levels reflect the prevailing risk and can be adjusted, for example, when local authorities advise of an increased likelihood of terrorist activity. Thus, a higher threat level in such system indicates a higher level of risk. One of the novel features of the invention is that the behavior of the system can change with a simple adjustment to the threat level. In response to a change of threat level there might be, for example, an increased number of random vehicle inspections at a particular facility, and the inspections may be more thorough.

Along with such change in behavior is the recognition that different tactics and strategies may be applicable to different facilities, and even at different locations within a facility. This is an important consideration because security threats vary significantly from facility to facility. The arrival of three oil trucks at a refinery, for example, presents a much lower risk than three trucks arriving at an embassy. Thus, an embodiment of the invention comprises a system that allows users to define factors that uniquely affect the security risk of certain events at a certain locale. The system can then change its behavior based on these custom risks and invoke various counter measures when threats are more likely. Accordingly, one embodiment of the invention provides for the use of contextual risk indicators in connection with threat level management.

### BRIEF DESCRIPTION OF THE DRAWINGS

FIG. 1 is a block schematic diagram that illustrates system architecture according to an embodiment of the invention;

FIG. 2 is a screen shot that shows a typical display available to a security supervisor in the control room according to an embodiment of the invention;

FIG. 3 is a screen shot that shows a dialog for threat level change according to an embodiment of the invention;

FIGS. 4A and 4B are screen shots that show the use of background colors, in this example different shades of gray, to indicate a prevailing threat level, e.g. a high threat level (FIG. 4A) and an elevated threat level (FIG. 4B), according to an embodiment of the invention;

FIG. 5 is a diagram of a threat level indicator that shows the High threat status according to an embodiment of the invention;

FIG. 6 is a flow diagram illustrates steps that may be followed to inboard an untagged vehicle according to an embodiment of the invention;

FIG. 7 is a block schematic diagram that illustrates an adaption mechanism that configures facility security infrastructure and that coordinates security personnel procedures based upon prevailing threat levels in a threat level management system according to the invention; and

FIG. 8 is a block schematic diagram that illustrates contextual risk indicators in a threat level management system according to the invention.

### DETAILED DESCRIPTION OF THE INVENTION

The presently preferred embodiment of the invention has four main modules:

An Arrival module: This is a browser-based application that is designed for guards to manage the entry and exit of vehicles.

A Supervisor module: This is a browser-based application for monitoring the overall system. It is expected to be used in a security control room but could, in fact, be used from any location.

A Mobile-officer module: This is an application for a handheld device that allows the mobile security workforce to read vehicle tags, manage inspections, look at history, enter inspection information, open and close barriers, and view video surveillance.

An Administrator module: This is the administrative system used to configure and manage the system.

### Inspections, Threat Levels, and Risk Assessment

One way that the invention improves protection from, for example, VBIEDs without creating a fortress, is by assessing the risk that each vehicle may contain an IED. Based on the risk assessment, the system can either mandate an inspection, or allow the vehicle to proceed. In other words, the invention focuses on the suspect vehicles, and lets the lower risk vehicles enter more quickly.

Fundamental factors affecting the risk include:
Is the vehicle known, i.e. is it tagged or a frequent visitor; and
What is the prevailing threat level?

The presently preferred embodiment of the invention supports the following four threat levels:
Normal (Green)
Elevated (Yellow)
High (Orange)
Severe (Red)

A higher threat level indicates a higher level of risk, for example, mandating a higher frequency of inspections at a particular facility.

### Configurable Behavior

Security practices vary significantly from facility to facility. The practices at the plant area of an oil refinery, for example, are necessarily different to those for an office tower with underground parking. An embodiment of the invention provides one system that can be configured to meet the varied operational policies across the spectrum of target customers.

Configurable elements can include, for example:
The average percentage of inspections that should be performed at each of the threat levels;
The classes of vehicles. One facility might have cars, SUVs, and trucks, for example, whereas a military installation may be configured with jeeps, troop carriers, two axle cargo, etc.;
The information that needs to be captured for each visiting vehicle, e.g. Reason For Visit, Identity of Visitor Person/Organization, Visiting Which Organization/Department, and Authorized Locations.

High level features of the invention include:
Registered vehicles are tagged and the system maintains vehicle, and authorized driver information, and whether fast track is on. Fast vtrack vehicles are reserved for known VIP vehicles and generally attract a very low incident of ad-hoc inspection when the threat level is Normal.
Information on non-registered vehicles is captured at point of entry, including a field that determines how long the user is allowed on the premises, and the ability to store photos of the vehicle including photos of the vehicle's license plate and its occupants.
Parking areas can be zoned with readers to alert when vehicles park in the wrong area.
Permitted Locations: in large facilities with distributed barriers, the system is configured to allow automated barrier opening based on the permitted locations.
Non-registered vehicles may be optionally given a tag that is returned upon departure. This allows the system to open barriers inside the facility automatically, and to alert if a car strays into an unauthorized, un-barricaded location.
Hardware Integration: the system operates standard security hardware including barriers, biometric readers, keypads, push buttons, etc.
The system, and additionally the guard, can determine when a vehicle must be inspected on both entry and exit. Note that a guard may request an inspection when the system does not, but a guard cannot override an inspection of the system mandates one.
The control room can set threat levels: higher threat levels result in more vehicle inspections.
The guard can submit an incident report, e.g. parked in unauthorized area, vehicle permitted duration expired.
Reports, on line and printed, showing vehicle activity, inspection activity, guard activity, and incidents.
An administrator can configure details, such as tolerance for inspections, information to capture during inspection, data retained about visitors, and fields for registered vehicles.
Messages can be sent between the control room and guards using both handheld devices and a browser.
Integrated Video: the system displays real-time surveillance for the Arrival application.
Both the handheld device and the Arrival applications have alarm buttons to alert the control room, and all other users, that an incident is in progress.

### Basic System Requirements

The invention preferably comprises the following basic system elements, the construction of any of which is within the skill of those who practice in the relevant art:

### Ethernet

The backbone of the system is an Ethernet network that connects multiple devices to a server. Devices that do not support Ethernet use native connections to an intermediate device, such as a PLC, I/O board or similar, and then from there via Ethernet to a server.

### Single-Server

The system is designed to work on a single applications server for each facility. A distributed multi-server topology is also within the scope of the invention.

### Secure Transmissions

Because the system is used to control access to highly secure areas, and is responsible for the triggering and suppression of potential critical alarms, the system must employ advanced techniques to ensure that hackers cannot disable or hijack the system. An embodiment of the invention, for example, employs a key encryption scheme that ensures that the messages to and from devices are guaranteed to be authentic.

### Redundant

Given the mission critical nature of security, the architecture should support redundant servers whereby if one server fails, another server can immediately replace it.

### Web-Based

The desktop application should be browser based, supporting remote access. The presently supported browsers are IE6+, Firefox 1.5+ and Safari 2.0+.

### Hand Held

Several functions should be available guard via a Windows CE equipped handheld device. The application largely functions in a connected mode, i.e. where 802.11 is available.

### Multi-Language

The architecture supports the application being configured to run in one of several languages.

### Failsafe Support

Given the mission critical nature of the application, the system is designed in such as a way that device operation, such as electric barriers, can be managed locally, even when the network is down.

### Overall System Configuration

Both the physical topology and the security policies, i.e. business processes, vary from facility to facility. Consequently each implementation must be configured to meet those unique requirements. The explanation of the system behaviors herein identifies the configurable elements that allow the system to adapt both visually and logically to the requirements of each individual facility.

### Risk Computation Concepts

A critical value of the invention is that it can compute the risk, for example, that a vehicle may be carrying a VBIED, and guide the security team accordingly, e.g. mandate an inspection, or require certain information to be gathered. Criteria that indicate a high risk at one facility may, in fact, be normal at another facility. For example, the arrival of an unmarked closed truck at a residential compound driven by a non-uniformed driver constitutes a higher risk than the same situation at an airport facilities gate. Consequently, the system includes a host of conditions where individual risk settings can be defined. These risk settings are configured at installation time and can be adjusted by a system administrator at any time. The administrator can associate many conditions/settings with these risk indicators. An embodiment of the invention supports the six risk levels, shown in Table 1, along with a neutral setting.

TABLE 1
Risk Levels
Risk Levels

| | |
|---|---|
| Level 0 | Neutral (does not affect the risk |
| | value) |
| Level 1 | Minor |
| Level 2 | Moderate |
| Level 3 | Significant |
| Level 4 | High |
| Level 5 | Very high |
| Level 6 | Mandatory Inspection |
| | (regardless of other low risk |
| | factors) |

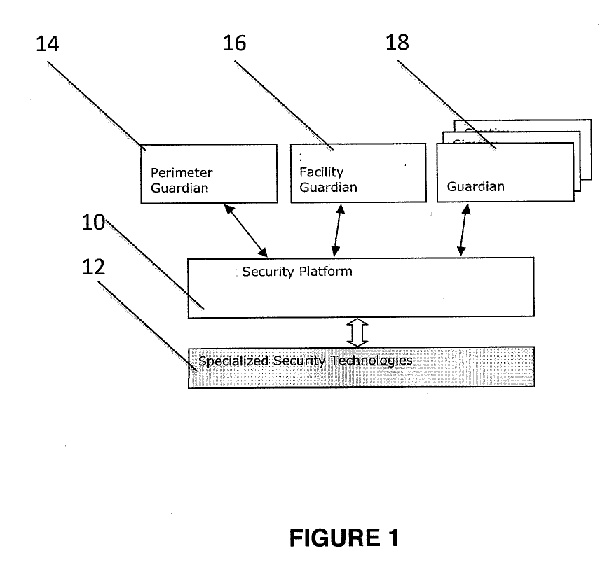

FIG. 1 is a block schematic diagram that illustrates system architecture according to an embodiment of the invention. In FIG. 1, there are shown at least two aspects of the invention, e.g. the perimeter guardian and the facility guardian (as well as capability for other features, such as the guardian module 18), as follows:

### Perimeter Guardian

The perimeter guardian module 14 provides a comprehensive security system that protects facilities from deadly VBIEDs. The system incorporates under-vehicle scanning for the identification of ordinance and contraband, along with sensors, surveillance, and barrier management. The perimeter guardian is integrated with a security platform 10 that functions to direct specialized security technologies 12, such as managing of devices, e.g. barriers, the gathering of sensor data, e.g. via vehicle sensors that determine when a vehicle is located in specific zone, managing traffic lights, the gathering of biometric data, and the management of data that are stored to an independent data store.

### Facility Guardian

The facility guardian module 16 allows one to track the location of people and assets discretely anywhere in a facility, in real time. The facility guardian module uses highly advanced RFID technologies to determine, for example, which people are in a specific room, or whether a visitor is unescorted in a secure area. This module is useful when it is necessary to know who is where, and who is with them, or where sensitive assets are at any given point in time.

### Overview

The strategy of building a comprehensive security platform allows maximum flexibility in responding to market demand. With the invention, security systems can be built in much less time because much of the functionality is already prefabricated in the platform. Thus, one aspect of the invention focuses on building systems in high threat situations where the security risks are significant, and where there is proven demand.

### EMBODIMENTS

The following embodiments of the invention are presented herein:

### System Adaption Based on Prevailing Threat Level

Threat levels are not a new concept in the security field, and even lay people are familiar with the threat levels adopted by the US Department of Homeland Security. Our systems, like much of the industry, uses four threat levels. The Dept. of Homeland Security uses a five level system. Threat levels reflect the prevailing risk and might be adjusted, for example, when local authorities advise of an increased likelihood of terrorist activity. In this example, a higher level indicates a higher risk. One of the novel features of the invention comprises a perimeter guardian module with which the behavior of the system can change with a simple adjustment to the threat level. There might be, for example, an increased number of random vehicle inspections and the inspections may be more thorough.

### Contextual Risk Indicators

Security threats vary significantly from facility to facility. The arrival of three oil trucks at a refinery, for example, presents a much lower risk than three trucks arriving at an embassy. This embodiment of the invention comprises a system that allows users to define factors that uniquely affect the security risk of certain events at a certain locale. The system can then change its behavior based on these custom risks and invoke various counter measures when threats are more likely.

### Threat Level Design

An embodiment of the system exhibits two classes of behavior regarding threat levels:

1) The administration of changing threat levels and the display of the active level; and
2) The change in system behaviors based on the prevailing threat level These two areas are discussed separately below.

### Threat Level Administration

### Introduction

An embodiment of the system supports four threat levels, i.e. normal, elevated, high, and severe.

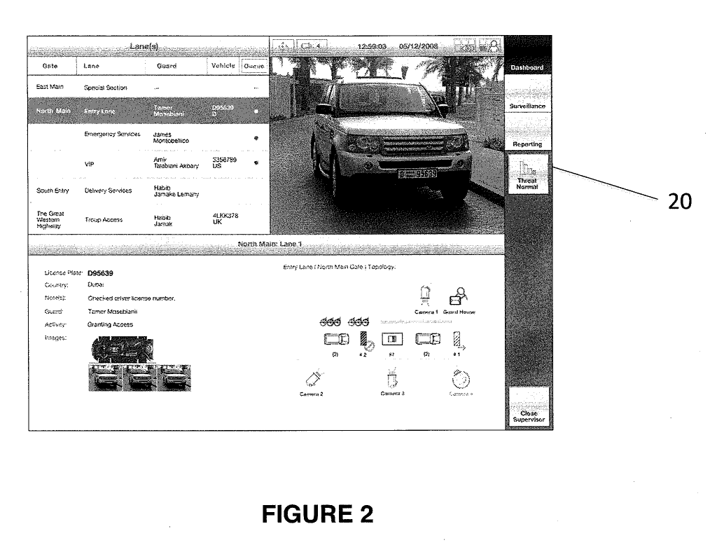

FIG. 2 is a screen shot that shows a typical display available to a security supervisor in the control room. Notice the threat level button 20 on the right side.

### Changing Threat Levels

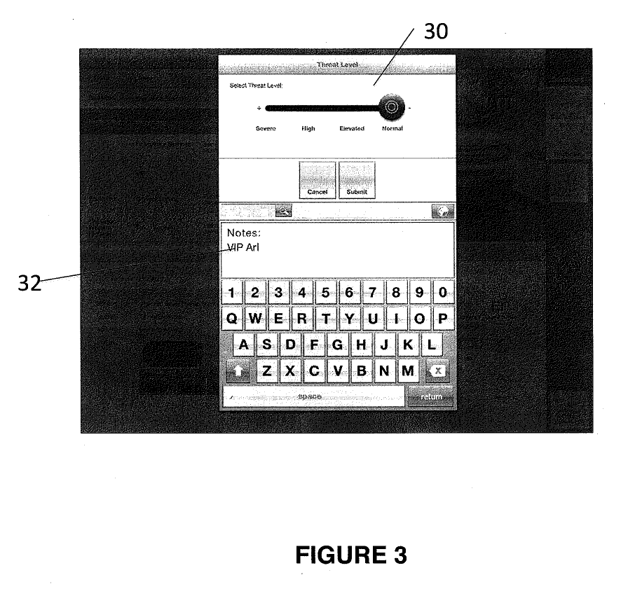

When a supervisor presses the threat level button, the threat level change functionality 30 is displayed, as depicted in FIG. 1. Notice in FIG. 3 that the supervisor can enter a note 32 when the threat level is changed. After submission, every user on the system is notified and the note is displayed as well.

### Threat Level Awareness

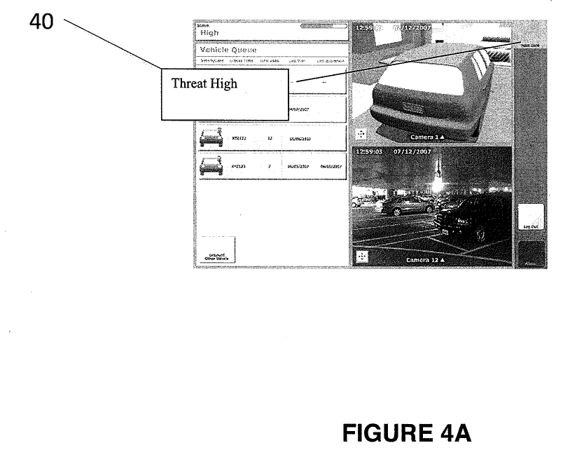

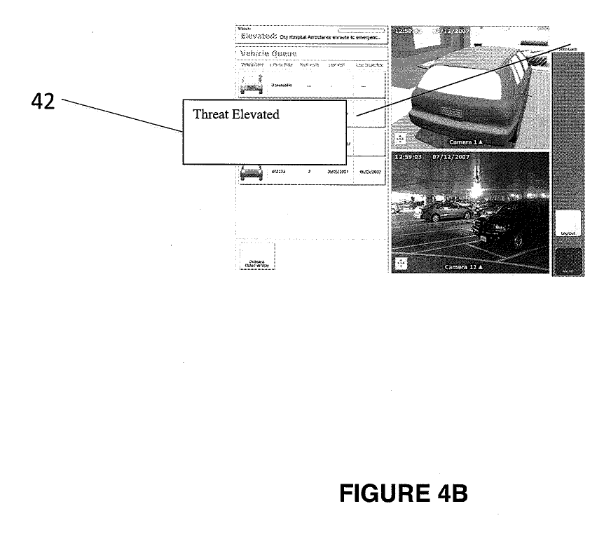

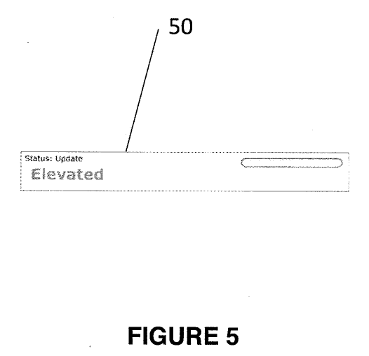

A number of mechanisms are used in the invention to ensure that the user is always aware of the prevailing threat level. One indication is that the application background skin uses a color system that reflects the prevailing threat level. This is shown in FIGS. 4A (threat high: 40) and 4B (threat elevated: 42) by shades of gray. In the preferred embodiment, the threat level would be indicated by a particular background color, and the use of shades of gray is only provided in FIGS. 4A and 4B for purposes of illustration herein. To reinforce the threat level, there is threat level indicator in the top left of the display. FIG. 5 is a diagram of a threat level indicator 50 that shows the high threat status.

### System Functionality Affected by the Prevailing Threat Level

Having gathered all of the risk influencing data, the system computes the overall risk potential and determines whether an inspection should be mandated.

The process involves the identification of risk factors, and a mechanism for empirically threat scoring each factor. As noted, the system is designed to allow new risk factors and new risk scores to be identified at anytime, so the following, represent examples, not a definite nor a complete list.

In the context of protection from VBIED, for example, the risk factors might include the following:
1. Number of occupants
2. Gender of occupants
3. Vehicle Load bearing capacity
4. Vehicle markings
5. Country of origin
6. Vehicle Owner Organization
7. Transparency
8. Frequency of Visit

In the first risk factor “No of occupants,” the threat score may be, e.g. 5 for a single driver, 4 for two occupants, 3 for three occupants, and 0 for four or more occupants.

In the case of Gender, if the occupants are all male then the threat score might be 3, reducing to 2 for 1 female, and to 0 for three or more females.

The process continues, identifying a risk factor and then providing an empirical way to score the threat. A vehicle that is capable of carrying a heavier load, a limousine'for example, has a higher potential threat than that of a Mini Cooper. A rental car is higher risk than a known company owned passenger car, and so forth

It is essential to recognize that a high threat vehicle may have one or more low scoring risk factors. This is particularly true if the actual risk factors are publicized. Over the past two years, for example, there has been an increase in the number of female suicide bombers because it became known that security authorities had long thought that women posed a lower threat than men.

Note that, in addition to the empirical computation of risk, the system attempts to achieve a certain percentage of inspections. The system also introduces a random factor to ensure that the system is not entirely predictable. This increases the chance of identifying, through inspection, a vehicle borne improvised explosive device (VBIED) that does not fit the normal risk profile.

### The On-boarding Process

A presently preferred embodiment of the invention supports up to eight specific steps to process an inbound untagged vehicle, but not all steps need to be taken every time. The system can be configured to skip one or more steps, based on risk levels and the data captured in previous steps. A facility may even elect to never execute certain steps. In other words, the process can adapt to factor the risk tolerance of the organization and the willingness to disrupt the traffic flow by mandating inspections and increasing the time taken to on-board a vehicle. The following discussion explains the supported steps and the configuration data that control the process flow.

### Process Flow

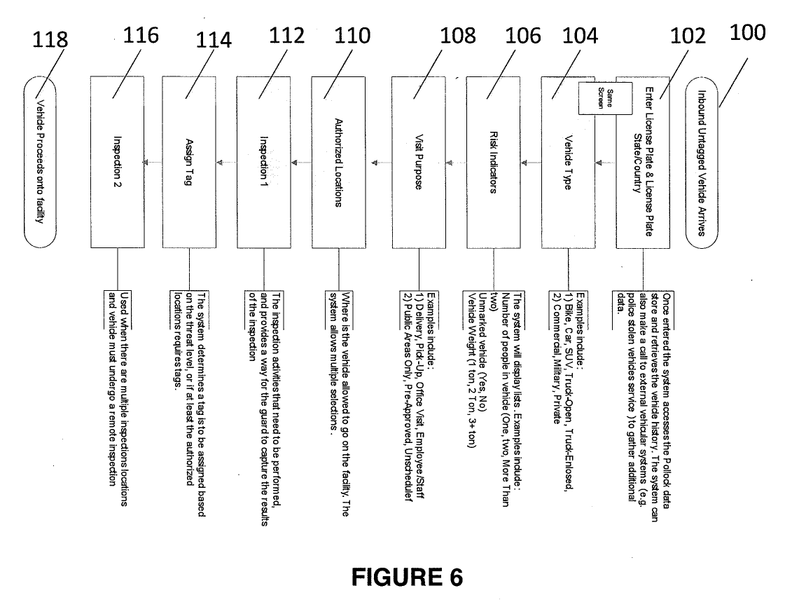

FIG. 6 is a flow diagram illustrates steps that may be followed to inboard an untagged vehicle. In this example, an inbound untagged vehicle arrives at a facility (100). The guard enters the license plate number and license plate state/country (102). Once this data is entered, the system accesses a system data store and retrieves the vehicle history. The system can also make a call to external vehicle systems, e.g. a police stolen vehicles service, to gather additional data.

On the same display screen in this example, the guard enters the vehicle type (104). Examples of vehicle type include: bicycle, car, SUV, truck-open, and truck-enclosed; and commercial, military, and private.

Risk indicators are then displayed (106). Examples of risk indicators include: number of people in the vehicle, e.g. one, two, or more than two; whether the vehicle is marked; and vehicle weight, e.g. one-ton, two-tone, three or more tons.

The visit purpose and access requested is then accessed (108). Examples of this include: delivery, pick-up, office visit, employee/staff; and access to public areas only, pre-approved access, and unscheduled.

Authorized locations are then identified (110). This determines where the vehicle is allowed to go within the facility. Multiple selections are provided.

At first inspection, Inspection 1, is specified (112) that describes activities to be performed by the guard and a mechanism for capturing the results of the inspection.

A tag is then assigned to the vehicle (114), based upon the threat level associated with the vehicle, if the location to be visited required a tag.

A second inspection, Inspection 2, may be indicated (116), e.g. where there are multiple inspection locations at the facility and the vehicle must undergo a remote inspection.

Finally, the vehicle may proceed to the facility (118).

### Adapting Based on Threat Level

The discussion above outlined the most comprehensive process flow to support inbound untagged vehicles. The full process flow, however, is not always executed. In certain low risk conditions, or at facilities where a faster and simpler approach is required, the system can be configured to skip certain steps. At the macro level, a system administrator can configure which of the steps are required at each threat level. Table 2 below illustrates how one facility is configured based on the threat levels. In Table 2, a 1 means include the step, and a 0 means skip it.

TABLE 2
Threat Level Configuration

| Steps | Level 1 | Level 2 | Level 3 | Level 4 |
|---|---|---|---|---|
| Vehicle Type | 1 | 1 | 1 | 1 |
| Risk Indicators | 0 | 1 | 1 | 1 |
| Visit Purpose | 0 | 0 | 1 | 1 |
| Authorized | 0 | 1 | 1 | 1 |
| Locations | | | | |
| Arrival Inspection | 1 | 2 | 3 | 4 |
| Set (minimum) | | | | |
| Always Tag | 0 | 0 | 1 | 1 |
| Visitors? | | | | |
| Departure | 0 | 0 | 1 | 1 |
| Inspection Set | | | | |
| (minimum) | | | | |

This mechanism allows the system to adapt its behaviors based on the prevailing risk, where the less the risk, the fewer the steps. Thus, certain activities are skipped at threat level 1, but all of the activities are mandatory for threat level 4. Note that the initial step for untagged vehicles of entering the license plate number is mandatory.

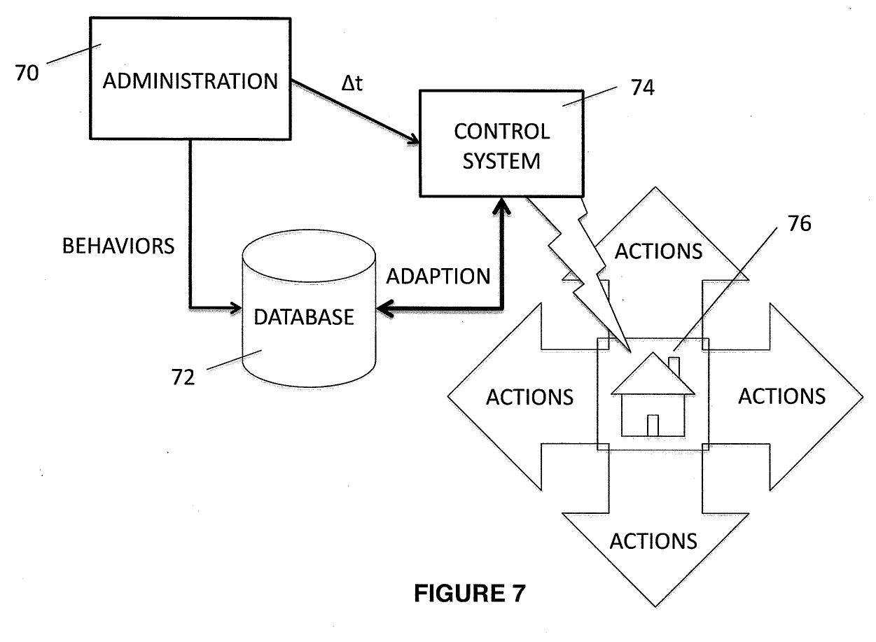

FIG. 7 is a block schematic diagram that illustrates an adaption mechanism that configures facility security infrastructure and that coordinates security personnel procedures based upon prevailing threat levels in a threat level management system according to the invention.

Key to this aspect of the invention is the ability to adapt a procedure such as, for example, gate entry, to various levels of threat. This embodiment of the invention allows a facility security procedure to be prepared that dynamically changes, based upon threat level. Based upon threat level, the guard at the gate is given a different set of procedures to follow, as indicated on a display screen, for example of a handheld device. The facility security manager can thus change procedures at that facility by changing the threat level. It is not necessary to provide new procedures or training to security personnel.

Even though the overall setting for a specific step may be ON, i.e. 1, the system may not require that step be executed because of some additional factors. However, the converse is not true: if the step is turned OFF, then regardless of other factors the step is skipped.

Consider risk indicators, for example. Risk Indicators are used to provide additional information that, for that facility, are considered to affect the risk assessment, e.g. number or people in the vehicle. The actual risk indicators that are requested are, however, dependent upon the vehicle type (as discussed later). If the risk indicators step is set to ON in the overall configuration (per Table 1 above), the guard may still not be presented with the risk indicators screen because it was not required for the selected vehicle type. Note that the risk indicators design is discussed elsewhere herein in connection with another embodiment of the invention.

As shown on FIG. 7, an administration facility 70 is used to describe facility behaviors at different threat levels. These behaviors are assigned by administrative personnel and are stored in a database 72. The administration facility may then set a facility threat level Δt by alerting a control system 74. The control system oversees all security related aspects of a facility 76, such as gate entry procedures for guards, alerts, gate operation, tag monitoring, etc. These security-related aspects of the facility are translated into various actions that are taken throughout the facility. The control system implements appropriate threat level actions in the facility in response to threat level changes by resorting to the database, which instructs the control system with regard to corresponding threat level behaviors. The control system also receives data from the facility security mechanisms, for example human input data, such as notes or alerts from security personnel, and sensor and monitoring data, such as explosive detectors, perimeter breach detection, motion detection, tag tracking, and the like. This information is provided to the database and provides a further degree of adaption to the overall system. Thus, threat levels may be raised or lowered as a result of control system feedback.

### Enter License Plate

Ascertaining whether the vehicle (1) is registered, (2) has been on the premises before, or (3) has some relevance to the authorities is an essential first step in determining the risk the vehicle poses. When the hardware determines a vehicle is waiting for entry, the system signals the vehicle presence and prompts the guard to enter the license plate and simultaneously indicate the vehicle type (discussed below) assuming that vehicle type is ON.

Along with the license plate input field, the system optionally allows the guard to indicate the country where the vehicle was licensed/registered. The list of countries and the default country can be configured by an administrator.

As soon as the license plate is entered, the guard can continue with the on-boarding process. In the background, the system checks the facility records to ascertain whether the vehicle is registered, and what history, i.e. if there have been any prior visits and whether there were any incidents/violations. The system also checks external sources, when available, to gather additional information about the vehicle, i.e. has it been reported as stolen. Not all facilities and clients have access to external vehicle databases.

An embodiment comprises a gateway that allows a thread to connect to an external source and in which results are collected while the system proceeds with registration. Problems are alerted to the gatehouse and the guard when they surface.

### Vehicle Type

Along with the license plate, the guard typically indicates the vehicle type. The types of vehicles that are relevant to one facility may never approach another facility. Consequently, the vehicle types are configured individually for each facility. In some situations the type of vehicle may not be captured at all. The system stores one set of vehicle types with the following logical elements being associated with each individual vehicle type:

<element name =”buttonname” type=”xs:string”/>
<element name =”tooltip” type=”xs:string”/>
<element name =”actiononselection” type=”xs:byte”/>
<element name =”onselectionprompt” type=”xs:string”/>
<element name =”risklevel” type=”xs:byte”/>
<element name =”visitpurposesetid” type=”xs:byte”/>

The actionsonselection element has the following supported values: 0, 1, 2 (none, display msg, prompt for string input).

The visitpurposesetid element indicates which, if any, of the Vistorpurpose selectionsare displayed (see section 0).

Based on the above schema, the XML skeleton in one embodiment has the following format:

```
<vehicletype>
    <prompt></prompt>
    <caption></caption>
    <button>
        <buttonname></buttonname>
        <buttonicon></buttonicon>
        <tooltip ></tooltip >
        <actiononselection></actiononselection>
        <onselectionprompt></onselectionprompt>
        <risklevel></risklevel>
        <visitpurposesetid></visitpurposesetid>
    </button>
</vehicletype>
```

### Example

Listed below is an example of a set of vehicle types in the XML format:

```
<vehicletype>
    <prompt>Select the type of vehicle:</prompt>
    <caption>Vehicle Type: </caption>
    <button>
        <buttonname>Car</buttonname>
        <tooltip> Any standard sedan excluding SUV
</tooltip>
        <actiononselection>0</actiononselection>
        <risklevel>2</risklevel>
        <visitpurposesetid>1</visitpurposesetid>
    </button>
    <button>
        <buttonname>SUV</buttonname>
        <tooltip>Any  passenger  carrying  utility
vehicle</tooltip>
        <actiononselection>0</actiononselection>
        <risklevel>2</risklevel>
        <visitpurposesetid>1</visitpurposesetid>
    </button>
    <button>
        <buttonname>Open Truck</buttonname>
        <tooltip>
```

Any ⅔ Axle vehicle truck without cargo walls:

</tooltip>
<actiononselection>2</actiononselection>
<onselectionprompt>

Enter any displayed hazardous cargo class and division numbers from the MOT sign:

```
    </onselectionprompt>
    <risklevel>3</risklevel>
    <visitpurposesetid>2</visitpurposesetid>
</button>
<button>
    <buttonname>Closed truck</buttonname>
    <tooltip>
    Any ⅔ Axle vehicle truck with cargo walls
    </tooltip>
    <actiononselection>2</actiononselection>
    <onselectionprompt>
```

Enter any displayed hazardous cargo class and division numbers:

```
        </onselectionprompt>
        <risklevel>3</risklevel>
        <visitpurposesetid>2</visitpurposesetid>
    </button>
    <button>
        <buttonname>Other</buttonname>
        <tooltip> You will be prompted to describe
the vehicle
        </tooltip>
        <actiononselection>2</actiononselection>
        <onselectionprompt>Enter  the  vehicle
description:
        </onselectionprompt>
        <risklevel>3</risklevel>
        <visitpurposesetid>3</visitpurposesetid>
    </button>
</vehicletype>
```

Note that these actual strings may be stored in multiple languages.

### Risk Indicators

Beyond the standard risk factors assessed by the system, e.g. how often the vehicle visits, the vehicle type, the authorized locations, etc., individual facilities may want to gather additional information to help ascertain the risk associated with allowing the vehicle on the facility. An embodiment provides risk indicators features to allow an administrator to add custom risk indicators. But, there is a limitation: this embodiment only supports single choice questions that do not require data entry, i.e. they behave much like radio buttons. In most situations this limitation can be overcome with the appropriate choice of options. Rather than prompting the guard, for example, to enter the number of occupants in the building by typing in a number, a series of buttons can be displayed to capture the same information, e.g. “1,” “2,” “3 or more.” In this way, the application can be simplified without significant loss of functionality.

There is one other compelling justification for this design constraint: If the guard is allowed to put in random values, the system has challenges calculating the risk associated with every input. As designed, each fixed input has a corresponding fixed risk value.

The system supports multiple risk indicator sets. The risk indicator set that is used is determined by the prevailing threat level. The system can be configured to use a single risk indicator set for all threat levels, or even no risk indicators whatsoever.

The following XML fragment illustrated the overall structure of the risk indicator set:

```
<riskindicators>
    <riskset>
        <riskprompt>
            <prompt></prompt>
            <caption></caption>
            <button>
                <buttonname></buttonname>
                <tooltip></tooltip>
    <actiononselection></actiononselection>
    <onselectionprompt></onselectionprompt>
                <risklevel></risklevel>
            </button>
        </riskprompt>
    </riskset>
</riskindicators>
```

### Example

Listed below is an example of one set of risk indicators:

```
<riskindicators>
    <riskset id=”1”>
        <riskprompt>
            <prompt>  How  many  people  in  the
vehicle?</prompt>
            <caption>Number of People:</caption>
            <button>
                <buttonname>1</buttonname>
                <tooltip>Only the driver</tooltip>
                <risklevel>4</risklevel>
            </ button>
            <button>
                <buttonname>2</buttonname>
                <tooltip> One passenger along with
the driver
                </tooltip>
                <risklevel>2</risklevel>
            </ button>
            < button>
                <buttonname>More  than
2</buttonname>
                <tooltip> Three or more occupants
    </tooltip>
                <risklevel>1</risklevel>
            </button>
        </riskprompt>
        <riskprompt>
            <caption>Is the vehicle marked with a
logo?
            </caption>
            <button>
                <buttonname>Yes</buttonname>
                <tooltip> The vehicle is showing a
commercial brand or logo
                </tooltip>
                <risklevel>2</risklevel>
            </button>
            <button>
                <buttonname>No  -
private</buttonname>
                <tooltip> The vehicle doesn't have
any markings but it does not appear to be commercial
in nature
                </tooltip>
                <risklevel>2</risklevel>
            </button>
            <button>
                <buttonname>No  -
commercial</buttonname>
                <tooltip>  The  vehicle  is  a
commercial  type,  but  it  does  not  show  any  visible
company logo's
                </tooltip>
                <risklevel>3</risklevel>
            </button>
        </riskprompt>
        <riskprompt>
            <caption>Indicate  the  driver's
gender</caption>
            <button>
                <buttonname>Male</buttonname>
                <risklevel>3</risklevel>
            </button>
            <button>
                <buttonname>Female</buttonname>
                <risklevel>2</risklevel>
            </button>
        </riskprompt>
        <riskprompt>
            <caption> Does  the  driver  appear  calm
and relaxed
            </caption>
            <button>
                <buttonname>Yes</buttonname>
                <tooltip>Appears relaxed</tooltip>
                <risklevel>2</risklevel>
            </button>
            <button>
                <buttonname>No</buttonname>
                <tooltip>  Appears  nervous  or
agitated </tooltip>
                <risklevel>3</risklevel>
            </button>
        </riskprompt>
    </riskset>
</riskindicators>
```

### Visit Purpose

The visit purpose identifies why the driver is trying to enter the facility. As discussed herein, the visit purpose set that is displayed is dependent upon the selected vehicle type: the reasons for a visit by a three-axle truck are likely to be different from those for a car. They can use the same set when appropriate.

As well as provide another factor to calculate risk, the system includes the Visit Purpose, so that the system can assist the guard in on-boarding the vehicle. When a specific visit purpose is selected the system can display an instruction to the guard. If the visit purpose, for example, is “bulk delivery of dry goods,” the system prompts the guard to call the warehouse supervisor to determine to which off loading area the vehicle should be directed. The visit purpose facility can also be used, where useful, to indicate who the occupants are here to visit.

The system stores multiple sets of visit purposes. Each set containing two or more buttons. The definition of the button schema is:

<element name =”buttonname” type=”xs:string”/>
<element name =”tooltip” type=”xs:string”/>
<element name =”actiononselection” type=”xs:byte”/>
<element name =”onselectionprompt” type=”xs:string”/>
<element name =”risklevel” type=”xs:byte”/>

Note that, as with vehicle type, the actionsonselection element has the following supported values: 0,1,2 (none, display msg, prompt for string input).

Based on the above schema, the XML skeleton would have the following format:

```
<visitpurposes>
    <purposeset id=”1”>
        <prompt></prompt>
        <caption></caption>
        <button>
            <buttonname></buttonname>
            <tooltip></tooltip>
            <actiononselection></actiononselection>
            <onselectionprompt></onselectionprompt>
            <risklevel></risklevel>
        </button>
    </purposeset>
</visitpurposes >
```

### Example

Listed below is an example of two sets of visitor purposes in the conceptual XML format:

```
<visitpurposes>
    <purposeset id=”1”>
        <purposeprompt>Indicate the purpose of the visit:
        </purposeprompt>
        <vp_button>
            <buttonname>Delivery or Pickup</buttonname>
            <tooltip>Includes  couriers,  mail  room,  and
non-bulk vendors deliveries
            </tooltip>
            <actiononselection>0</actiononselection>
            <risklevel>3</risklevel>
        </vp_button>
        <vp_button>
            <buttonname>Bulk Delivery of Dry Goods
            </buttonname>
    <actiononselection>2</actiononselection>
            <onselectionprompt>Call  x254  and  speak  to
the warehouse supervisior to determine where to direct the
vehicle. #13Enter the supervisors name:</onselectionprompt>
            <risklevel>3</risklevel>
        </vp_button>
        <vp_button>
            <buttonname>Maintenance</buttonname>
            <tooltip>Any  vehicle  that  is  bringing
contractors  to  conduct  facility  maintenance  or
repair</tooltip>
            <actiononselection>2</actiononselection>
            <onselectionprompt>Review  the  maintenance
approval form. #13 Then enter the maintenance company name,
and contract number</onselectionprompt>
            <risklevel>3</risklevel>
        </vp_button>
        <vp_button>
            <buttonname>General  Office
Visit</buttonname>
            <tooltip>Includes  salesmen,  partners,
interviewees, etc
            </tooltip>
            <actiononselection>0</actiononselection>
            <risklevel>2</risklevel>
        </vp_button>
        <vp_button>
            <buttonname>Job Interview</buttonname>
            <tooltip>Anyone coming to interview with HR
or a staffer
            </tooltip>
            <actiononselection>1</actiononselection>
            <onselectionprompt>Get  the  interviewee
names, then call x198 and alert HR that the personnel are
inbound
            </onselectionprompt>
            <risklevel>2</risklevel>
        </vp_button>
    </purposeset>
    <purposeset id=”2”>
        <purposeprompt>Indicate the purpose of the visit:
        </purposeprompt>
        <vp_button>
            <buttonname>Commercial</buttonname>
            <tooltip>Delivery,  Pickup,  Maintenance,
etc</tooltip>
            <actiononselection>0</actiononselection>
        <risklevel>3</risklevel>
        </vp_button>
        <vp_button>
            <buttonname>Office</buttonname>
            <tooltip>Anyone  visiting  staff  in  office
(excluding) delivery activities
            </tooltip>
            <actiononselection>0</actiononselection>
            <risklevel>2</risklevel>
        </vp_button>
    </purposeset>
</visitpurposes>
```

### Authorized Locations

The authorized location function is primarily designed for larger facilities that have multiple areas or locations, where vehicles can drive and/or park, e.g. visitor parking, disabled parking, main loading bay, laboratory loading bay, etc. In simpler situations, where there is one general parking area, i.e. park wherever you can, this phase of the process flow can be skipped.

Controlling where vehicles park is an essential component of the facility security, and consequently the system has a rich set of features related to Authorized Locations to ensure that a broad array of situations can be adequately accommodated. Listed below are some of the main features.

Vehicles can be authorized to one or multiple locations. Some facilities have a large number of locations, and may have very specific sub-locations where a vehicle should park, e.g. a specific parking place. Consequently, the Authorized Location selections can be grouped into a taxonomy, providing an efficient way for the guard to navigate to a specific location, as opposed to having a very long flat list of all the locations to which a vehicle may be authorized. A guard, for example, may select a specific building. Having selected the building, the system then displays the subset of locations that are connected to that building. The guard then chooses parking lot “A” as the place where the vehicle is authorized. In a more complicated setup, a guard may select a specific parking structure, then select a floor, then select a space on that floor, etc.

The system can be configured to have buttons for multiple locations, e.g. “All commercial loading bays,” or “Any visitor parking lot.” Conceptually, it is similar to a multi-location set, selectable at the press of a button.

Each location setting option may have an associated prompt, to provide information to the guard applicable to the selected location, or request that the guard capture and enter some information.

Risk levels can be assigned to each location setting. Vehicles allowed to park under the building, for example, have a higher risk setting than those parking adjacent to the perimeter.

Due to physical constraints, sometimes all of the locations may not be accessible from a specific facility entry gate. The delivery entry for commercial vehicles, for example, may not allow entry to the office parking. The displayed locations are therefore contextually dependent upon the specific gatehouse where the guard is logged in.

In facilities that have RFID readers to ensure that vehicles only go where they are authorized, or that have locked throughways, e.g. a parking barrier, the system is configured behind the scenes with physical zones and throughways, representing the physical layout. Each location includes a set of underlying permissions to access the zones and throughways that are appropriate for the vehicle to access the authorized locations.

On same facilities, assignment of a vehicle tag may only be required for certain locations. Each location, therefore, has a property that indicates whether a tag should be assigned. Note that a global setting “Always assign a tag” requires a tag to be assigned regardless of the selected location setting.

To support the above features, the data defining locations includes two different entities: folders and locations. <locationfolder> and <location>, respectively.

A folder may contain other folders and/or locations, and contains the following elements:

<element name =”foldername” type=”xs:string”/>
<element name =”tooltip” type=”xs:string”/>
<element name =”risklevel” type=”xs:byte”/>
<element name =”finalselection” type=”xs:boolean”/>

The <locationfolder> tag may also contain one or more <gatehouse> tags as follows:

<element name =”gatehouse” type=”xs:integer”/>
<element name =”locationid” type=”xs:integer”/>

The folder icon is the name of an icon file, as described in vehicle type.

<finalselection> is an element only tag, i.e. contains no date but other tags that, when present, indicates that the upon selection the vehicle being authorized to access all of the locations contained within the folder. Conversely, folders that do not contain a <finalselection> tag, when selected result in a display of the children of the folder, i.e. other folders and locations contained one layer down within the folder. The <finalselection> tag is only valid when the folder (or its sub-folders) contains at least one valid <location> tag.

The <risklevel> acts as a default for all child folders and locations, but is overruled by any specific settings contained within the children nodes when the <finalselection> is false. When final selection is true, the risk level is applied regardless of risk levels of the children. The system should however warn an administrator if they try to set a <risklevel> that is lower than its children.

As with <risklevel>, the values for <gatehouse>, acts as defaults for all child folders, and are overruled based on the same logic.

<locationfolder> tags do not contain full definitions of child locations, rather they <locationid> tags that identify the locations within that folder.

This mechanism allows each location to be accessed from multiple folders, with requiring the location details (discussed below) to be redefined in every folder that contains it.

The structure of the <location> entity is defined with the following:

<element name =”locationname” type=”xs:string”/>
<element name =”locationid” type=”xs:integer”/>
<element name =”tooltip” type=”xs:string”/>
<element name =”actiononselection” type=”xs:byte”/>
<element name =”onselectionprompt” type=”xs:string”/>
<element name =”risklevel” type=”xs:byte”/>
<element name =”tagrequired” type=”xs:boolean”/>

The <location> entity supports the following multi-use tags:

<element name =”gatehouse” type=”xs:integer”/>
<element name =”zone” type=”xs:integer”/>
<element name =”throughway” type=”xs:integer”/>

Note that, as with vehicle type, the actionsonselection element has the following supported values: 0,1,2 (none, display msg, prompt for string input).

Based on the above schemas, listed below is an empty XML skeleton showing the basic framework:

```
<locations>
    <folder>
        <foldername></foldername>
        <tooltip></tooltip>
        <finalselection></finalselection>
        <risklevel></risklevel>
        <gatehouse></gatehouse>
        <gatehouse></gatehouse>
        <locationid></locationid>
        <locationid></locationid>
        <folder>
            <foldername></foldername>
            ....
        </folder>
    </folder>
    <location>
        <locationname></locationname>
        <locationid></locationid>
        <tooltip></tooltip>
        <actiononselection></actiononselection>
        <onselectionprompt></onselectionprompt>
        <risklevel></risklevel>
        <tagrequired></tagrequired>
    </location>
    <location>
        <locationname></locationname>
        <locationid></locationid>
        <tooltip></tooltip>
        <actiononselection></actiononselection>
        <onselectionprompt></onselectionprompt>
        <risklevel></risklevel>
        <tagrequired></tagrequired>
    </location>
</locations>
```

### Example

Listed below is an example of an authorized location implementation in the conceptual XML format. The data are represented by the following hierarchy:

```
<locations>
    <folder>
        <foldername>Main Complex</foldername>
        <finalselection>1</finalselection>
        <gatehouse>1</gatehouse>
        <gatehouse>2</gatehouse>
        <locationid>1</locationid>
        <locationid>2</locationid>
    </folder>
    <folder>
        <foldername>Garages</foldername>
        <gatehouse>1</gatehouse>
        <locationid>3</locationid>
        <locationid>4</locationid>
    </folder>
    <folder>
        <foldername>Commercial Areas</foldername>
        <gatehouse>2</gatehouse>
        <locationid>5</locationid>
        <locationid>6</locationid>
        <locationid>7</locationid>
    </folder>
    <locationid>8</locationid>
    <folder>
        <foldername>Anywhere</foldername>
        <finalselection>1</finalselection>
        <gatehouse>1</gatehouse>
        <gatehouse>2</gatehouse>
        <locationid>1</locationid>
        <locationid>2</locationid>
        <locationid>3</locationid>
        <locationid>4</locationid>
        <locationid>5</locationid>
        <locationid>6</locationid>
        <locationid>7</locationid>
        <locationid>8</locationid>
    </folder>
    <location>
        <locationname>Guest Parking</locationname>
        <locationid>1</locationid>
        <actiononselection>0</actiononselection>
        <risklevel>1</risklevel>
        <zone>1</zone>
    </location>
    <location>
        <locationname>Staff Parking</locationname>
        <locationid>2</locationicon>
        <actiononselection>0</actiononselection>
        <risklevel>2</risklevel>
        <zone>2</zone>
        <zone>3</zone>
        <zone>4</zone>
        <zone>5</zone>
    </location>
    <location>
        <locationname>Garage 1</locationname>
        <locationid>3</locationid>
        <actiononselection>0</actiononselection>
        <risklevel>3</risklevel>
        <zone>9</zone>
    </location>
    <location>
        <locationname>Garage 2</locationname>
        <locationid>4</locationid>
        <actiononselection>0</actiononselection>
        <risklevel>3</risklevel>
        <zone>7</zone>
        <zone>8</zone>
    </location>
    <location>
        <locationname>Main Warehouse</locationname>
        <locationid>5</locationid>
        <actiononselection>0</actiononselection>
        <risklevel>3</risklevel>
        <zone>10</zone>
        <zone>11</zone>
        <zone>12</zone>
        <zone>13</zone>
        <zone>14</zone>
    </location>
    <location>
        <locationname>Mailroom</locationname>
        <locationid>6</locationid>
        <actiononselection>0</actiononselection>
        <risklevel>3</risklevel>
        <tagrequired>1</tagrequired>
        <zone>22</zone>
    </location>  <location>
        <locationname>Laboratory Dock</locationname>
        <locationid>6</locationid>
        <actiononselection>1</actiononselection>
        <onselectionprompt>Call x123 and confirm!
        </onselectionprompt>
        <risklevel>4</risklevel>
        <tagrequired>1</tagrequired>
        <zone>99</zone>
    </location>
    <location>
        <locationname>VIP Parking</locationname>
        <locationid>7</locationid>
        <actiononselection>2</actiononselection>
        <onselectionprompt>Enter  the  VIP  Auth
Number!
        </onselectionprompt>
        <risklevel>4</risklevel>
        <tagrequired>1</tagrequired>
        <zone>27</zone>
    </location>
</locations>
<phew!>
```

### Inspection and On-Boarding

Based on all the information gathered in the prior steps, the system computes whether an inspection is mandated or is optional, based on an assessment of risk, as discussed above. The system supports multiple different inspection definitions, i.e. the information that needs to be checked during an inspection. The actual inspection set applied depends on the threat level. The <actiononselection> feature is used to prompt the guard for input when the item is selected. The guard is not forced to select and indicate every facet of the inspection. Inspection may be discretionary and the guard may decide only to look in the trunk, for example. By selecting an inspection item the guard is indicating that particular part of the inspection has been performed.

The inspection set may support two special behaviors:
Display notes, where the guard can enter additional info in a free form text field; and
An inspect-on-exit field that provides a way for the guard to mandate that the vehicle should be inspected on exit. This feature can be used to reduce theft, and make sure that items brought onto the premises are, in fact, removed. It is not strictly a VBIED counter measure, but it has sufficient ancillary merit to be included.

At gate houses that are defined to have secondary inspection facilities, the guard can elect to conduct some or all of the inspection at the gate, or defer some or all of the inspection to the secondary gate area. Once this stage is completed, the guard may optionally assign an RFID tag, after the assignment (if mandated) the system either opens the gate for secondary inspection, or opens the appropriate gates to allow the vehicle to proceed to the afore-authorized locations.

### Data Formats

The system can store multiple sets of inspection details. Each set containing one or more buttons. The (standard) definition of the button schema is:

<element name =”buttonname” type=”xs:string”/>
<element name =”tooltip” type=”xs:string”/>
<element name =”actiononselection” type=”xs:byte”/>
<element name =”onselectionprompt” type=”xs:string”/>

Note that, as with vehicle type, the actionsonselection element has the following supported values: 0,1,2 (none, display msg, prompt for string input).

Based on the above schema, the XML skeleton has the following format:

```
<inspections>
    <inspectionset id=”1”>
        <prompt></prompt>
        <caption></caption>
        <displaynotes></displaynotes>
    <displayinspectonexit></displayinspectonexit>
        <button>
            <buttonname></buttonname>
            <tooltip></tooltip>
            <actiononselection></actiononselection>
            <onselectionprompt></onselectionprompt>
        </button>
    </inspectionset>
</inspections >
```

### Example

Listed below is an example of two sets of inspection settings in the conceptual XML format:

```
<inspections>
    <inspectionset id=”1”>
        <caption>Standard</caption>
        <displaynotes>1</displaynotes>
    <displayinspectonexit>0</displayinspectonexit>
        <button>
            <buttonname>Engine
Compartment</buttonname>
    <actiononselection>0</actiononselection>
        </button>
        <button>
            <buttonname>Under Carriage</buttonname>
    <actiononselection>0</actiononselection>
        </button>
        <button>
            <buttonname>Stowage/Trunk</buttonname>
    <actiononselection>0</actiononselection>
        </button>
    </inspectionset>
    <inspectionset id=”2”>
        <caption>Thorough</caption>
        <displaynotes>1</displaynotes>
    <displayinspectonexit>1</displayinspectonexit>
        <button>
            <buttonname>Engine
Compartment</buttonname>
    <actiononselection>0</actiononselection>
        </button>
        <button>
            <buttonname>Under Carriage</buttonname>
    <actiononselection>0</actiononselection>
        </button>
        <button>
            <buttonname>Stowage/Trunk</buttonname>
    <actiononselection>2</actiononselection>
            <onselectionprompt>Enter the contents
            </onselectionprompt>
        </button>
        <button>
            <buttonname>Stowage/Trunk</buttonname>
    <actiononselection>0</actiononselection>
        </button>
        <button>
            <buttonname>Explosive
Swipe</buttonname>
    <actiononselection>2</actiononselection>
            <onselectionprompt>Enter  the  test
number and reading
            </onselectionprompt>
        </button>
        <button>
            <buttonname>Visitor IDs</buttonname>
    <actiononselection>2</actiononselection>
            <onselectionprompt>Enter  the  ID  type,
number and name
            </onselectionprompt>
        </button>
    </inspectionset>
</inspections>
```

### Tag Assignment

The system can be configured to support the temporary assignment of tags to vehicles. There are two purposes for this:
One to provide a way to validate that the vehicle travels and parks in authorized locations; and
To support the automatic opening and closing of barriers when the campus has internal barricaded areas.

Whether or not a tag is required depends on the threat level (as discussed above), or if the approved area requires a tag, i.e. the location has <tagrequired> set to true. If a tag is required, the system advises the guard and requires that the guard either:
enter the identity of the selected tag; or
places the tag close to a proximity reader to automatically capture the tag ID.

The guard then gives the tag to the driver, and the gatehouse activities are completed for that vehicle.

### Inspection 2

At gatehouses where there is a secondary inspection area, the guard at the gatehouse can decide to delegate some or all of the inspection to the security staff at the secondary location. At least one guard at the secondary location is logged into the system and has indicated that they are manning the secondary inspection area. When any guard indicates that a vehicle is to be inspected at that location, a device emits an audible indication that a new vehicle has been added to the queue. When the guard is ready to perform the inspection, they can select the vehicle, based on its license plate, and view vehicle information, i.e. the data the guard entered during the process flow. The guard also has the vehicle history and the results of any external vehicle checks available. The guard can then view the same buttons, as a Web application, on a handheld device, with similar behaviors, e.g. pop-up prompts, indications of the task performed, etc.

Having indicated the completion of the inspection the system closes the record, removes the vehicle from the queue, and the system automatically opens the gate allow the vehicle to proceed onto the premises. If a tag has been assigned, the tag is only set to support the approved locations when the inspection has been completed.

### Inspection Determination

One of the central counter measures offered by the system is the system's automatic determination of which vehicles to inspect and when. Different situations, however, create different risk profiles at different facilities. The following is a discussion of the algorithms that determine whether or not an inspection should be performed.

Important Note: it is essential that the specific algorithms are not discussed with customers, prospects, analysts, etc. If people understand the specific way the implementation of the system works, they could potentially ascertain ways to circumvent the system.

### Contextual Risk Indicators Design

### Introduction

Both physical topology and security policies, i.e. business processes, vary from facility to facility. Consequently, each implementation must be configured to meet such unique requirements. During the following discussion of system behaviors, the configurable elements that allow the system to adapt both visually and logically to the requirements of each individual facility are described. Note that, for clarity of communication, it is assumed that administrator configurable data is structured in XML. The final data format is decided by engineering choice and may not necessarily comprise an XML schema. The discussion herein, therefore, does not necessarily adhere to strict conventions for XML schemas. Rather, the goal of this discussion is to convey the spirit of the data types, their relationships, and their impact on the process flow.

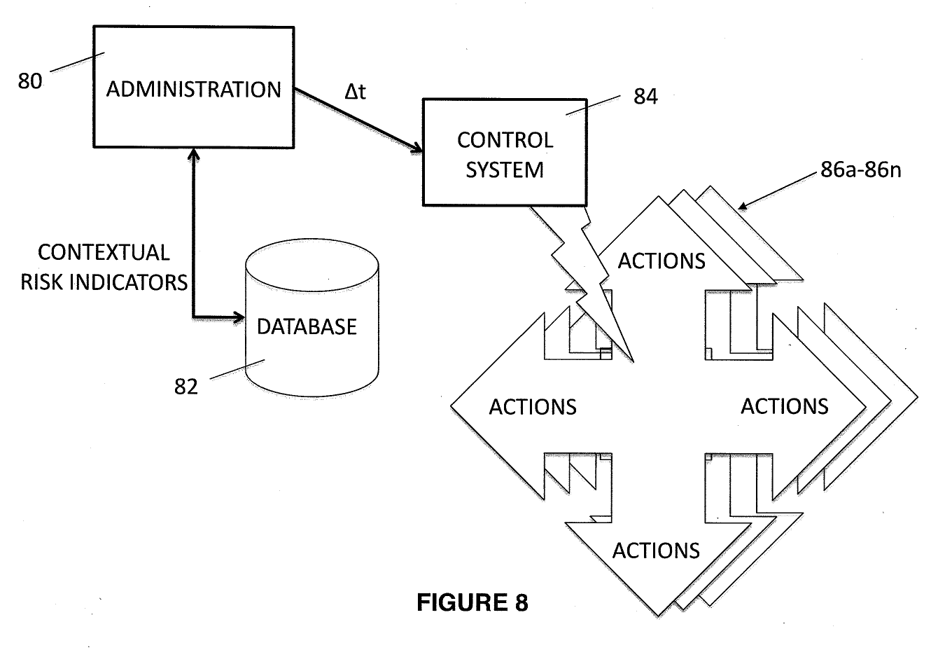

FIG. 8 is a block schematic diagram that illustrates contextual risk indicators in a threat level management system according to the invention. In FIG. 8, an administration facility 80 is used to describe facility behaviors at different threat levels. These behaviors are assigned on a contextual basis to a plurality of facilities and/or locations, e.g. some areas of a facility may be contextually differentiated from other areas of the same facility, or facilities within a geographically dispersed enterprise may be contextually differentiated. Such contextual behaviors are assigned by administrative personnel and are stored in a database 82. The administration facility may then set a facility threat level Δt at any of the facilities by alerting a control system 84. The control system oversees all security related aspects of each of the contextual realms of each facility or portion of a facility 86a-86n, such as gate entry procedures for guards, alerts, gate operation, tag monitoring, etc., which behaviors are different at each facility or portion of a facility based upon context. These security-related aspects of each facility or portions of a facility are translated into various actions that are taken throughout the facility or at each specific portion of the facility. The control system implements appropriate threat level actions in response to threat level changes by resorting to the database, which instructs the control system with regard to corresponding threat level behaviors, and which also instructs the control system with regard to contextual risk indicators.

As previously stated, security policies differ from facility to facility (or even within a facility), and one main reason is because normal non-threatening behavior in one facility, may portend a very serious security breach in another.

Here is an example:

A limousine arriving at a corporate office may be a commonplace occurrence because of the frequent arrival and departures of VIPs, but the arrival of a limousine at a fuel loading dock may be much less commonplace. Because limousines have been used by terrorists to carry large quantities of ordinance, there is clearly a risk that the limousine is a VBIED. However, because of the rarity of this occurring at the second location, the limousine may present a higher risk at the fuel dock.

Conversely, the arrival of an unmarked and covered semi-truck might be commonplace at the loading dock, and distinctly uncommon at a corporate office. In this case the risk would be high at the office and low at the dock.

In another simple example, deep tinted windows at a Swedish facility may be abnormal and indicate the potential for ordinance to be hidden inside the passenger compartment, yet a similar vehicle in Riyadh would not connote increased risk. The Swedish system might have a simple prompt to determine whether or not the vehicle has tinted windows

The system could be configured to have a list of custom vehicle types along with risk threat values associated with it.

In another example, one facility may have an appointments system where most visitor vehicles are scheduled and known before they arrive. In such an environment, non-scheduled vehicles may be allowed on premises, but only after a rigorous search. Such a policy could not be applied at a location where appointments are not scheduled, e.g. a shopping mall.

Another common security premise is that risks increase when there is an increase in the value of the assets being protected. What constitutes a significant change in asset value is, again, contextual, and so the system should support contextual risk indicators. In the case of a corporate office, the risk may increase when a Senator or Sheik is on premises, in the case of the loading dock, it may be when a VLCC, i.e. the largest tankers in the world, are being filled, or perhaps, when the VLCC is registered in the USA.

When configuring the system, the administrator must identify each of the unique risk indicators, as well as define the possible choices, and the risk associated with each choice.

### Risk Indicators

Beyond the standard risk factors assessed by the system, e.g. how often the vehicle visits, the vehicle type, the authorized locations, etc., security administrators of individual facilities may want to gather additional information to help ascertain the risk associated with allowing the vehicle on the facility. An embodiment of the invention, provides risk indicators, as well as features that allow an administrator to add custom risk indicators. This ability for the system to incorporate unique risk factors is one of the factors that make the system novel.

The system supports multiple risk indicator sets. The current risk indicator set is determined by the prevailing threat level (as previously discussed). The system can be configured to use a single risk indicator set for all threat levels, or even no risk indicators whatsoever.

### Risk Computation Concepts

One critical value of the system is that it can compute the risk that a vehicle may be carrying a VBIED and thus guide the security team accordingly, e.g. mandate an inspection, or require certain information to be gathered. Criteria that indicate a high risk at one facility may, in fact, be normal at another facility. For example, the arrival of an unmarked closed truck at a residential compound driven by a non-uniformed driver constitutes a higher risk than the same situation at an airport facilities gate. Consequently, the system includes a host of conditions where individual risk settings can be defined. These risk settings are configured at installation time and can be adjusted by a system administrator at any time. The administrator can associate many conditions/settings with these risk indicators. The presently preferred embodiment of the invention supports the six risk levels shown in Table 3 below, along with a neutral setting.

TABLE 3
Risk Levels
Risk Levels

| | |
|---|---|
| Level 0 | Neutral (does not affect the risk |
| | value) |
| Level 1 | Minor |
| Level 2 | Moderate |
| Level 3 | Significant |
| Level 4 | High |
| Level 5 | Very high |
| Level 6 | Mandatory Inspection |
| | (regardless of other low risk |
| | factors) |

### Example

The system can capture the vehicle type, e.g. car, SUV, truck, etc. Each vehicle type has an associated risk level. In this example, a car is configured with a risk level of 2, for example, and a truck with a risk level of 3. Other factors, such as number of passengers, can introduce additional risk computations.

### Settings

An embodiment of the system can be configured to collect custom data that can be assigned a risk value for each supported response. A passenger vehicle being assessed for explosive threat, for example, would prompt security personnel to enter the number of passengers into the system. A response of five passengers is typically be assigned a much lower risk than one passe nger because car bombers tend to travel alone.

Collecting data can take time and slow down throughput through security perimeters. Consequently, the collection of custom threat level data can be configured to apply only at specified threat levels. When the threat level is normal, for example, the system may not require the gate house guard to identify the number of passengers. But, when the threat level is elevated, the guard must determine the passenger count.

### Example

The following XML fragment provides a non-limiting example that illustrates how a set of customer risk indications is specified:

```
<riskindicators>
    <riskset>
        <riskprompt>
            <prompt></prompt>
            <caption></caption>
            <button>
                <buttonname></buttonname>
                <tooltip></tooltip>
                <actiononselection></actiononselection>
                <onselectionprompt></onselectionprompt>
                <risklevel></risklevel>
            </button>
        </riskprompt>
    </riskset>
</riskindicators>
```

### Example

Listed below is an example of one set of risk indicators:

```
<riskindicators>
    <riskset id=”1”>
        <riskprompt>
            <prompt>  How  many  people  in  the
vehicle?</prompt>
            <caption>Number of People:</caption>
            <button>
                <buttonname>1</buttonname>
                <tooltip>Only the driver</tooltip>
                <risklevel>4</risklevel>
            </ button>
            <button>
                <buttonname>2</buttonname>
                <tooltip> One passenger along with the
driver
                </tooltip>
                <risklevel>2</risklevel>
            </  button>
            < button>
                <buttonname>More than 2</buttonname>
                <tooltip>  Three  or  more  occupants
    </tooltip>
                <risklevel>1</risklevel>
            </button>
        </riskprompt>
        <riskprompt>
            <caption>Is the vehicle marked with a logo?
            </caption>
            <button>
                <buttonname>Yes</buttonname>
                <tooltip>  The  vehicle  is  showing  a
commercial brand or logo
                </tooltip>
                <risklevel>2</risklevel>
            </button>
            <button>
                <buttonname>No - private</buttonname>
                <tooltip> The vehicle doesn't have any
markings but it does not appear to be commercial in nature
                </tooltip>
                <risklevel>2</risklevel>
            </button>
            <button>
                <buttonname>No  -
commercial</buttonname>
                <tooltip>  The  vehicle  is  a  commercial
type, but it does not show any visible company logo's
                </tooltip>
                <risklevel>3</risklevel>
            </button>
        </riskprompt>
        <riskprompt>
            <caption>Indicate  the  driver's
gender</caption>
            <button>
                <buttonname>Male</buttonname>
                <risklevel>3</risklevel>
            </button>
            <button>
                <buttonname>Female</buttonname>
                <risklevel>2</risklevel>
            </button>
        </riskprompt>
        <riskprompt>
            <caption> Does the driver appear calm and
relaxed
            </caption>
            <button>
                <buttonname>Yes</buttonname>
                <tooltip>Appears relaxed</tooltip>
                <risklevel>2</risklevel>
            </button>
            <button>
                <buttonname>No</buttonname>
                <tooltip> Appears nervous or agitated
</tooltip>
                <risklevel>3</risklevel>
            </button>
        </riskprompt>
    </riskset>
</riskindicators>
```

### Computer System Overview

Those skilled in the art will appreciate that the invention herein is implemented in a computer. For purposes of example, and not by way limitation a computer comprises a processor, main memory, storage media, input devices, and peripherals, all coupled together by a system bus. The computer may exist in a network or any one or more of its individual elements may be distributed across a network. The storage media comprises a mass storage and zero or more other drives. The mass storage comprises an operating system and one or more regular applications, such as a Web browser. For the sake of simplicity, only these components are discussed. If so desired, computer system may comprise additional components.

### Processor

The processor is the component responsible for executing instructions to provide the overall functionality of the computer system. For purposes of the invention, the processor may be any type of processor that is capable of executing any type of computer instructions. For the sake of simplicity, only one processor is herein. However, it should be noted that the computer system may comprise additional processors, if so desired.

### Main Memory

The main memory provides the memory needed by the processor to execute programs. More specifically, the processor uses the main memory to store program instructions while those instructions are being executed. In addition, the processor uses the main memory to store data and other information generated during the execution of instructions. Furthermore, the main memory may be used to store the computer system state information. The use and management of the main memory is discussed in greater detail below.

### User Interface

Various output components may include, for example, a video card, a video display, an audio card, and a set of speakers. These components enable the computer system to provide information to a user. The input devices enable the user to provide information to the computer system. The input devices may include, for example, a keyboard, an infrared receiver for receiving infrared signals, such as signals from a remote control, and a cursor control device such as a mouse, a trackball, a remote-controlled pointing device, etc. Basically, anything that enables the computer system to interface with a user can be included as user interface components.

### Storage Media

The storage media provides non-volatile storage for the computer system. The storage media may comprise a mass storage magnetic hard drive, and zero or more other drives. The other drives may include, for example, a floppy drive, a CD-ROM drive, a DVD drive, a CD-RW drive, etc. The drives enable the computer system to read from and write to storage media other than hard drive. All of the storage media may be accessed via a common controller interface, such as an IDE interface. While the storage media are described herein as drives, it should be noted that storage media need not be drives but, rather, may take on other forms, for example, disk-on-chip modules, flash memory, etc. All possible forms are within the scope of the invention.

The mass storage comprises a plurality of programs, including an operating system and one or more applications. The operating system is the general-purpose operating system that is loaded and executed during a regular boot-up process to provide an overall operating environment for the computer system. The applications, such as a Web browser, run within the environment provided by the operating system. For purposes of the invention, the operating system may be any operating system, including but not limited to Windows XP®. The inventive algorithm herein described is implemented in an application program.

### Peripherals

In addition to the components already described, the computer system may further comprise other peripherals, such as printers, scanners, network cards, RFID readers, etc. These peripherals may interface with the computer system via various ports and interfaces, such as parallel ports, serial ports, USB ports, SCSI interfaces, etc. Generally, any device that is capable of interfacing with the computer system can be included as one of the peripherals.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for contextually adapting security mechanism behavior in a security system, comprising the steps of:
providing an administration processor for a security mechanism for a plurality of locales within one or more facilities, said processor automatically and continuously examining autonomous and user-operated facility monitoring mechanisms and comparing same with user-defined factors that uniquely affect the security risk of certain defined events at a certain specified locale to determine location-based contextual behavior
said processor storing said user-defined factors and said location-based contextual behaviors in a database;
communicating at least one event to a control system associated with said administration processor;
said control system adapting a current configuration of said security mechanism in accordance with said at least one event by altering operation of security features associated with each of said plurality of locales and by altering communicated security procedures and a manner in which said security procedures are communicated for each of said plurality of locales, based upon said location-based contextual behavior.

2. The method of claim 1, further comprising the steps of:
said control system monitoring for changes in status at least one locale, wherein said changes comprise any of physical changes established by any of a plurality of detection means and virtual changes established by data input; and
said control system communicating said monitored status changes to said database for use by said administration facility in determining establishment of, and altering responses of, said security mechanisms, based upon said location-based behavior.

3. The method of claim 1, further comprising the step of;
establishing with said processor a plurality of threat levels and corresponding threat level behaviors for said facilities.

4. The method of claim 3, comprising at least four threat levels, including:
normal, elevated, high, and severe;
wherein a higher threat level indicates a higher level of risk.

5. The method of claim 1, wherein responses of said security, in view of said location-based contextual behavior, are altered by any of:
changing an average percentage of inspections that should be performed at each of the threat levels;
changing response based upon the classes of vehicles entering or within a facility; and
changing an amount of information that needs to be captured for each vehicle visiting the facility.

6. The method of claim 1, wherein, depending upon said location-based contextual behavior, any of:
registered vehicles are tagged and the database maintains vehicle, and authorized driver information, and whether a fast track feature is on, in which vehicles are reserved for known VIP vehicles and generally attract a very low incident of ad-hoc inspection when the threat level is Normal;
information on non-registered vehicles is captured at point of entry, including a field that determines how long a user is allowed on the premises, and the ability to store photos of the vehicle including photos of the vehicle's license plate and its occupants;
parking areas are zoned with readers to alert when vehicles park in a wrong area;
permitted locations are established and maintained, where in large facilities with distributed barriers, automated barrier opening is allowed based on the permitted locations;
non-registered vehicles may be optionally given a tag that is returned upon departure to allow barriers to be opened inside the facility automatically, and to alert if a car strays into an unauthorized, un-barricaded location;
hardware integration is provided which operates standard security hardware including barriers, biometric readers, keypads, push buttons, etc.;
a determination is made when a vehicle must be inspected on both entry and exit, wherein a guard may request an inspection when an inspection is not made automatically;
a control room can set threat levels, where higher threat levels result in more vehicle inspections;
a guard can submit an incident report;
reports, on line and printed, showing vehicle activity, inspection activity, guard activity, and incidents, may be provided;
an administrator can configure details, including tolerance for inspections, information to capture during inspection, data retained about visitors, and fields for registered vehicles;
messages can be sent between a control room and guards using both handheld devices and a browser;
integrated video displays real-time surveillance for an arrival application; and
both a handheld device and an arrival application have alarm buttons to alert a control room, and all other users, that an incident is in progress.

7. The method of claim 1, further comprising the step of:
said administration facility providing an individual risk settings facility with which a plurality of conditions and settings can be defined at installation time and can be adjusted by a system administrator at any time to establish a location-based contextual behavior.

8. The method of claim 1, further comprising the step of:
providing a perimeter guardian module integrated with a security platform to direct specialized security technologies, gathering of sensor data, gathering of biometric data, and management of data that are stored to an independent data store.

9. The method of claim 1, further comprising the step of:
providing a facility guardian module for tracking a location of people and assets discretely anywhere in at least one locale, in real time.

10. The method of claim 3, said administration facility addressing a plurality of classes of behavior in view of a location-based contextual behavior, including any of:
administering and/or changing threat levels and displaying an active threat level; and
changing behaviors for one or more locales.

11. The method of claim 3, further comprising the step of:
providing a security supervisor facility comprising a threat level control with which threat level change functionality and/or level is displayed, in view of said location-based contextual behavior.

12. The method of claim 3, further comprising the step of:
providing a prevailing threat level indication comprising an application background having a color or grey scale system that reflects a prevailing threat level, based upon said location-based contextual behavior.

13. The method of claim 1, further comprising, based upon said location-based contextual behavior, the steps of:
identifying risk factors; and
empirically threat scoring each factor.

14. The method of claim 13, wherein said risk factors comprise any of the following:
number of occupants, gender of occupants, vehicle load bearing capacity, vehicle markings, country of origin, vehicle owner organization, transparency, and frequency of visit.

15. The method of claim 3, further comprising the step of;
taking a predetermined minimum number of actions without regard to threat level, based upon location-based contextual behavior.

16. The method of claim 1, further comprising the step of:
introducing a random factor to ensure that actions at one or more locales are not entirely predictable.

17. The method of claim 1, further comprising the step of:
adapting to factor risk tolerance of an organization and willingness to disrupt operations at one or more locales into actions to be taken, based upon said location-based contextual behavior.

18. The method of claim 1, further comprising the step of:
adapting behaviors at one or more locales based on prevailing risk, where the less the risk, the fewer the steps for a particular behavior.

19. The method of claim 1, further comprising the step of:
providing a plurality of risk Indicators that provide additional information that, for a particular locale, are considered to affect risk assessment.

20. An apparatus for adapting security mechanism behavior in a security system, comprising:
an administration facility processor for a security mechanism for a plurality of locales within one or more facilities, said processor automatically and continuously examining autonomous and user-operated facility monitoring mechanisms and comparing same with user-defined factors that uniquely affect the security risk of certain defined events at a certain specified locale to determine location-based contextual behavior;
a database for storing said user-defined factors and said location-based contextual behaviors;
means for communicating at least one event to a control system associated with said administration processor;
said control system further comprising means for adapting a current configuration of said security mechanism in accordance with said at least one event by altering operation of security features associated with each of said plurality of locales and by altering communicated security procedures and a manner in which said security procedures are communicated for each of said plurality of locales, based upon said location-based contextual behavior.

21. The apparatus of claim 20, said processor further comprising;
a mechanism for establishing a plurality of threat levels and corresponding threat level behaviors for said facilities.

22. The apparatus of claim 21, comprising at least four threat levels, including:
normal, elevated, high, and severe;
wherein a higher threat level indicates a higher level of risk.

23. A security mechanism, comprising:
an administration facility processor for describing facility behaviors with regard to user-defined factors that uniquely affect the security risk of certain defined events at a certain specified locale;
said administration facility comprising means for assigning said behaviors on a contextual basis to a plurality of facilities and/or locations, said assigned behaviors comprising said contextual risk indicators;
a database for storing said contextual risk indicators;
said administration facility comprising means for adapting a current configuration of said security mechanism in accordance with said at least one event at any of said facilities and/or locations by alerting a control system;
said control system comprising means for overseeing all security related aspects of each contextual realms of each facility and/or location;
wherein behaviors are different at each facility and/or location based upon context;
means for translating security-related aspects of each facility and/or locations into various actions that are taken throughout said facility and/or location; and
said control system comprising means for implementing appropriate actions in response to one or more of said factors by resorting to said database, which instructs said control system with regard to corresponding behaviors, and which also instructs said control system with regard to said contextual risk indicators.
